(19) United States
(12) Patent Application Publication
(10) Pub. No.: US 2019/0122559 A1
(43) Pub. Date: Apr. 25, 2019

(54) SYSTEM AND METHOD FOR SITUATION ANALYSIS OF AN AUTONOMOUS LANE CHANGE MANEUVER

(71) Applicant: Continental Automotive Systems, Inc., Auburn Hills, MI (US)

(72) Inventors: Xian Zhang, Shelby Township, MI (US); Graham Lanier Fletcher, Auburn Hills, MI (US)

(21) Appl. No.: 16/216,377

(22) Filed: Dec. 11, 2018

Related U.S. Application Data
(63) Continuation of application No. PCT/US2017/036790, filed on Jun. 9, 2017.
(60) Provisional application No. 62/348,357, filed on Jun. 10, 2016.

(51) Int. Cl. G08G 1/16; G05D 1/00; B60W 30/09

(52) U.S. Cl. CPC G08G 1/167; G05D 1/0088; G05D 1/0055; G05D 2201/0213; B60W 2550/20; B60W 2550/308; B60W 2900/00; B60W 30/09

(57) ABSTRACT

An autonomous driving system for a vehicle includes an autonomous lane change safety check method. An object relative to the vehicle and a current lane of travel is mapped and object data of the object is assessed. An object threat value for the object is assigned based on the object map and the object data. The object is grouped based the object threat value. An overall critical value is determined from the object threat value for the object and filtered to reduce signal noise. The critical value is compared to a predetermined criticality threshold, where the lane change safety check is failed when the critical value is over the threshold.

### TECHNICAL FIELD

The present disclosure relates to automotive vehicles, and more particularly to automated driving scenarios and systems for automotive vehicles.

### BACKGROUND

An automotive vehicle commonly includes sensor arrays and cameras mounted to the vehicle to detect objects in the area proximate to the vehicle for various safety systems for the vehicle and the driver. The various safety systems utilize the data to provide warnings to the driver to minimize and/or avoid collisions.

These sensor arrays and cameras can provide warnings to the driver, such as a blind spot warning if a vehicle is present in a blind spot for the driver. Lane change warnings alert a driver if they are unintentionally drifting toward another lane and lane change assist can warn a driver if they are intentionally changing lanes but a vehicle may be rapidly approaching from the rear in the newly intended lane of travel.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In one exemplary embodiment, a method of implementing an autonomous lane change safety check for a vehicle includes selecting at least one object from sensor data for analysis with an electronic control unit (“ECU”). The method also includes mapping the at least one object relative to the vehicle and a current lane of travel with the ECU. The method further includes assessing the object data of at least one object for at least one of the relative object position, object velocity, relative object velocity, and intended vehicle path with the ECU. The method also includes assigning an object threat value for the at least one object based on the object map and the object data. The method further includes grouping with the ECU the at least one object based the object threat value. The method also includes determining with the ECU an overall critical value from the object threat value for the at least one object and filtering with the ECU the critical value to reduce signal noise. The method further includes comparing with the ECU the critical value to a predetermined criticality threshold, wherein the lane change safety check is failed when the critical value is over the threshold.

In one exemplary embodiment, an autonomous driving system for a vehicle includes an ECU for receiving sensor data from a plurality of vehicle sensors. The ECU includes instructions for implementing an autonomous lane change safety check technique. The technique includes selecting at least one object from the sensor data for analysis. The technique also includes mapping the at least one object relative to the vehicle and a current lane of travel. The technique further includes assessing the object data of at least one object for at least one of the relative object position, object velocity, relative object velocity, and/or intended vehicle path. The technique also includes assigning an object threat value for the at least one object based on the object map and the object data. The technique further includes grouping the at least one object based the object threat value. The technique also includes determining an overall critical value from the object threat value for the at least one object. The technique further includes filtering the critical value to reduce signal noise. The technique also includes comparing the critical value to a predetermined criticality threshold, wherein the lane change safety check is failed when the critical value is over the threshold.

### BRIEF DESCRIPTION OF THE DRAWINGS

The present disclosure will become more fully understood from the detailed description and the accompanying drawings, wherein:

FIG. 1 is a schematic view of a vehicle having an autonomous lane change feature of the present invention in a first exemplary driving scenario;

FIG. 2 is a schematic view of the vehicle of FIG. 1 in a second exemplary driving scenario;

FIG. 3 is a schematic view of the vehicle of FIGS. 1-2 in a third exemplary driving scenario; and

FIG. 4 is a schematic view a method of implementing the autonomous lane change safety check;

FIG. 5 is a schematic view a method of determining an object threat value for used with the lane change safety check of FIG. 4.

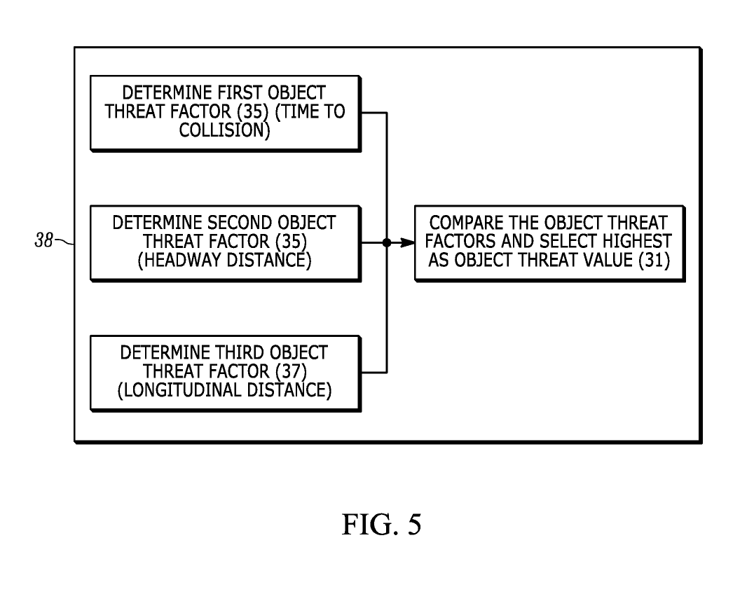

### DETAILED DESCRIPTION

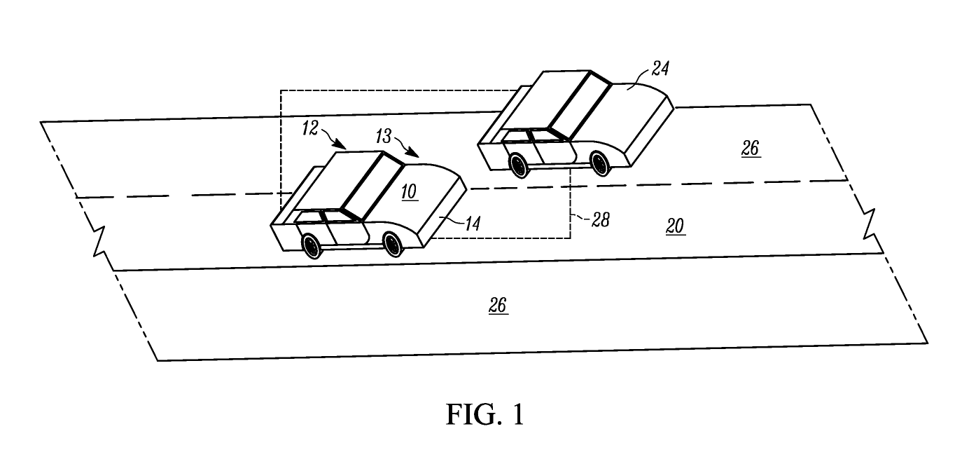

The following description is merely exemplary in nature and is in no way intended to limit the disclosure, its application, or uses. For purposes of clarity, the same reference numbers will be used in the drawings to identify similar elements. FIGS. 1-3 are schematic illustrations of a vehicle 10 having an autonomous driving system 12 with an autonomous lane change feature 13. The autonomous driving system 12 and autonomous lane change feature 13 includes performing a safety check 30 of the surrounding area.

The autonomous lane change feature 13 preferably incorporates other existing vehicle 10 systems and may utilize the same sensors and components, as described below. The autonomous lane change feature 13 provides highly automated or autonomous capacity for the vehicle 10 to change into another lane of traffic without requiring input from the driver. In particular, for merging into another lane of traffic travelling in the same direction or merging into another lane that is stationary, such as a road side or a lane closed due to construction, etc. The autonomous lane change feature 13 can therefore be used to continue driving along a current/planned vehicle path or to stop the vehicle, such as flat tire, car trouble, etc.

The autonomous lane change feature 13 may be connected to other systems for the vehicle 10, including a blind spot monitoring system, forward and rear facing camera(s), radar(s), lidar(s), and/or proximity sensors, collective referred to as sensors 14. The assisted traffic merged feature 12 utilizes the sensors 14 located at various points around the vehicle 10 and is capable to view the entire surrounding area around the vehicle. The sensors 14 may be used for another vehicle system, such as blind spot monitoring, lane change assist, side view monitoring, etc.

The autonomous lane change feature 13 utilizes an electronic control unit (“ECU”) 18. The ECU 18 may be a separate ECU 18 to provide control for the autonomous lane change feature 13 or may also be used by another vehicle system, such as the autonomous driving system 12. The ECU 18 receives input from the various sensors 14. The sensors 14 may be located separately or together at various locations. One skilled in the art would be able to determine which sensors and the locations of the sensors that may provide useful information to the autonomous lane change feature 13. The sensors may include but are not limited to any of a external facing cameras, radar, lidar, wheel speed sensors, steering wheel angle sensors, etc. In addition the autonomous lane change feature 13 may also use map data.

The vehicle 10 is in a current lane 20 at a current vehicle location 22. The autonomous lane change feature 13 and safety check 30 use the sensor 14 information reported to the ECU 18 to anticipate whether objects 24 in a merging lane 26 will intersect with the vehicle 10 during the autonomous lane change maneuver. If the ECU 18 will determine that the objects 24 will not interfere during the entire maneuver location 28 include the immediate area that will be directly in the path of the vehicle 10 once the lane change is complete.

The maneuver location 28 is based on the instantaneous status of the vehicle 10 position and velocity, as well as the instantaneous status of the objects 24 positions and velocities. History location of the objects 24 may also be used if available, i.e. the vehicle 10 may track objects 24 in the vicinity as the vehicle 10 travels.

The autonomous driving system 12 (by way of ECU 18 or another ECU) may decide that an autonomous lane change maneuver is desired. Some examples where a lane change maneuver is desired are: mechanical or other trouble is detected, slow moving traffic in the current lane of travel, upcoming turn required from another lane of travel, current lane of travel ends, oncoming construction, parked cars, or other obstacle in the current lane of travel, etc.

At this point the ECU 18 would run an algorithm based on the data/images from the sensors 14 to detect if there are obstacles 24. The ECU 18 or another ECU may merge the data from the sensors 14 to provide sensor fusion which is used for the autonomous lane change feature 13 and safety check 30.

The ECU 18 may also provide instructions to adjust the vehicle behavior in a manner to allow the vehicle 10 to change to the desired lane of travel. That may include speeding up or slowing down to merge with the flow of traffic in the desired lane or waiting until an object 24 has been passed or the new lane begins.

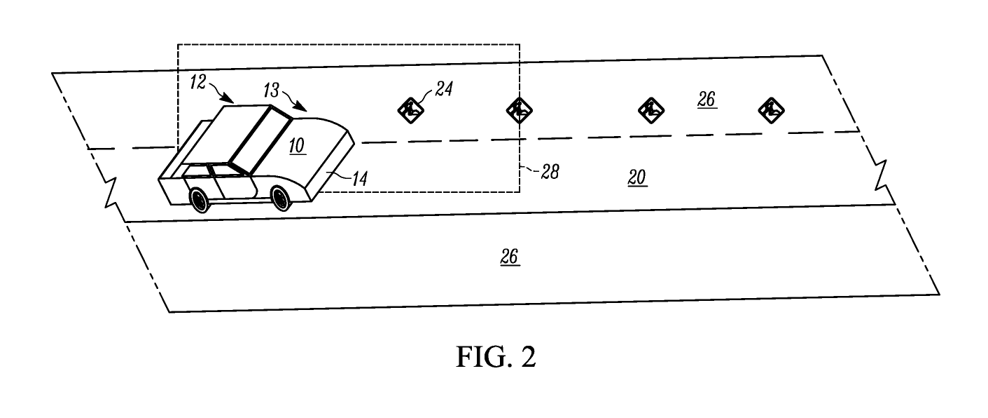

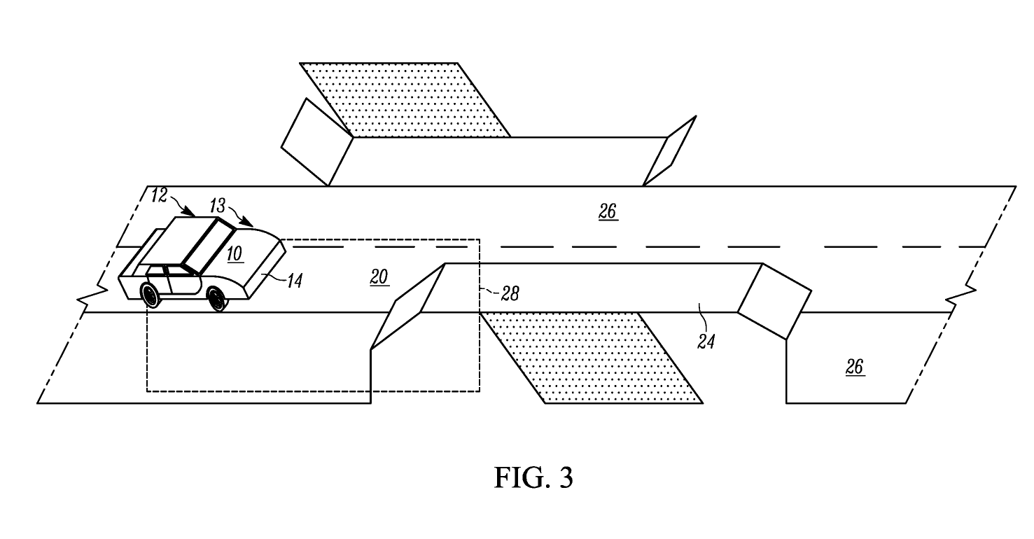

FIGS. 1-3 show some examples of a lane change scenario for use of the autonomous lane change feature 13 and safety check 30. The vehicle 10 is in a current lane of travel 20 and desires to move to a new lane 26. The new lane 26 is illustrated as an adjacent lane of travel in the same direction, or the lane along the side of the road. The ECU 18 identifies objects 24 which may be in the area 28 of the lane change maneuver and that may interfere with the lane change to provide a quick and robust safety check 30. In FIG. 1 the object 24 is another vehicle travelling in the same direction as the vehicle 10. In FIG. 2 the object 24 is construction in the adjacent lane of travel. In FIG. 3 the object 24 is an oncoming bridge in the lane at the side of the road. The ECU 18 plots a vehicle path to autonomous change lanes and avoid the objects 24. For example, slowing down in FIG. 1 or waiting to pass the objects in FIG. 2 or 3. As is illustrated, the autonomous lane change feature 13 can be used to autonomously change lanes in either lateral direction of the vehicle 10

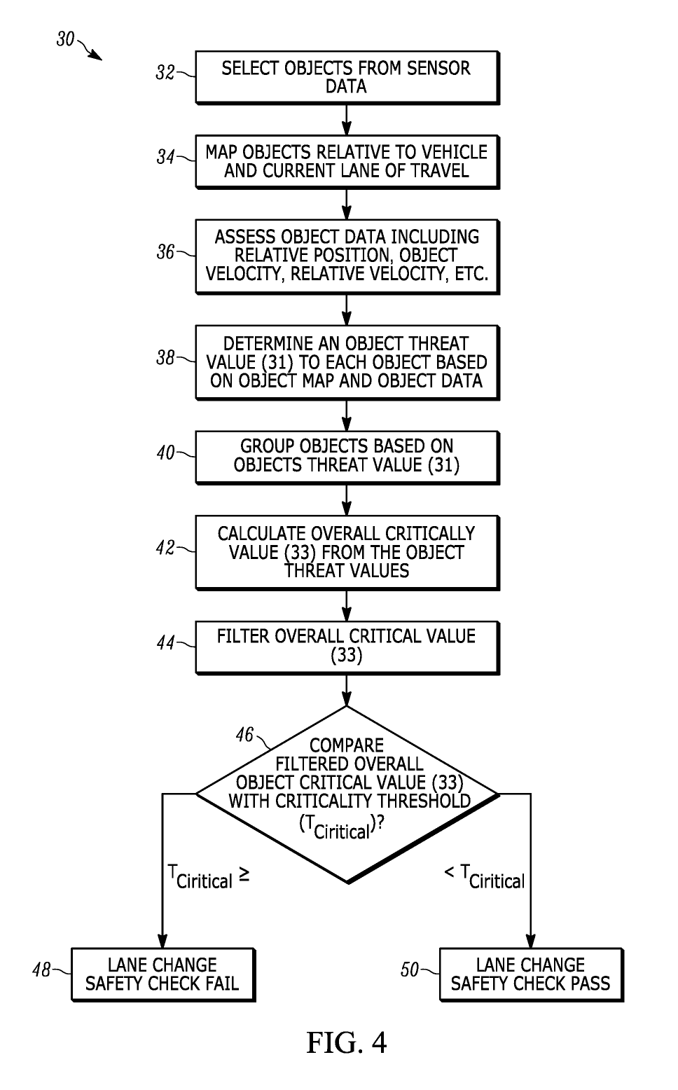

FIG. 4 illustrates a method of implementing the autonomous lane change feature algorithm 30 within the ECU 18. The autonomous lane change feature algorithm performs a safety check 30. The ECU 18 selects objects from the sensor data, step 32. The objects are selected based on this status such as measurements status, dynamic properties, position etc. The objects 24 may be selected from an object fusion module that fuses the sensor 14 outputs into one location, such as the ECU 18, for analysis.

The ECU 18 then maps the objects relative to the vehicle 10 and the current lane of travel 20, step 34. The object map is uses available lane information and maps the objects to a point relative to the current vehicle position and trajectory, e.g. center of the current lane 20. Available lane information includes map and sensor data that will need to be available in order to have a lane change maneuver.

The ECU 18 assesses the object data, step 36. That is assess the threat of the identified objects 24 based on the intended lateral direction of the lane change to the new lane 26. The object data includes at least one of, but is not limited to: the relative object position, object velocity, relative object velocity, intended vehicle path, etc.

In step 38, the ECU 18 assigns an object threat value 31 to each object 24 based on the object map obtained in step 34 and the object data assessed in step 36. The object threat value 31 assigned may vary from 0 to 1 for each object 24. Correctly quantifying/assessing the object threat value 31 of each surrounding object lays out the necessary foundation for later steps of calculating an overall criticality value 33 for the autonomous lane change feature 13.

The object threat value 31 for each object 24 is determined based on multiple factors, illustrated in FIG. 4. Although three factors are discussed, in another embodiment more factors may be considered in determining the object threat value 31. One skilled in the art would be able to determine additional factors which may be useful in assessing an object threat.

First a Time-to-collision (TTC)-based threat value factor 35 is calculated. One possibility for calculating the TTC factor 35 is with a piecewise linear function calcTTC (TTC, TTC_threshold(assignedLane,VelX)), where TTC_threshold is a function of the relative lane the object 24 is in and also its relative longitudinal velocity. Generally, the smaller the TTC, the higher the threat value factor 35.

Secondly, if the object is in front of the host vehicle, calculate a headway-distance-based threat value factor 37, For example, with a piecewise linear function such as calcCriticalityValueHdWy(T_{d},PosX,VelX), where T_{d} is the safe headway time used to calculate the safe headway distance, PosX and VelX are the relative longitudinal position and velocity, respectively.

Third if the object is in the adjacent lane of the host vehicle and in relatively close distance longitudinally, a third threat value factor 39 is assigned. In this instance the threat value factor 39 is assessed to be 1. If the object is not relative close longitudinally the threat value factor may be set to 0. The longitudinal distance (DL) threshold for this comparison should cover the width of the new/adjacent lane 26 in which the vehicle 10 will move to during the lane change maneuver.

All threat value factors 35, 37, 39 are compared to one another and the maximum of the three is taken to be the threat value 31 for that object 24.

The objects 24 are grouped based the object threat value 31, step 40. After calculating a threat value 31 for each selected surrounding object 24 a function takes all the threat values 31 as inputs and calculates the overall criticality value 33, step 42. The overall critically value function should satisfy at least the following conditions: 1) the overall criticality value 33 thus calculated is larger than any individual threat value 31; 2) the overall criticality value 33 is smaller than the sum of all the individual threat values 31; 3) the overall criticality value 33 is less than 1. For example, an instance of the function implementation could be:

overallCriticalityValue=min((ΣᵢthreatValueᵢ^{z})^{1/z}, 1),

where z is some positive even integer.

The ECU 18 filters the overall critical value, step 44, to quickly and accurately perform a safety check of the autonomous lane change. That is, the ECU 18 filters the overall critical value 33 to reduce signal noise. The filter may be based on an exponentially moving average of the overall critical value 33 to robustly assess the surrounding objects and prevent misdetection of objects 24 and to smooth out sensor noise. Thus, the filter may improve safety and analysis time of the vehicle 10 for the autonomous lane change feature 13.

The filtered overall lane change criticality value 33 is compared with a predefined criticality threshold (T_{critcal}) to determine whether it's safe or not to make a lane change, step 46. If the filtered overall criticality value 33 is larger than the safe threshold, the lane change safety check is said to fail, shown at 48. If below the criticality threshold the safety check is passed, shown at 50.

Some application examples based on the lane change safety check pass result are: at manual driving mode, if it's unsafe to make a lane change to a certain direction and the driver is initiating a lane change to that direction by either switching the signal light on or turning the steering wheel, some form of warning (sound alert or haptic warning) is supposed to be given to the driver.

In an autonomous driving mode, if a lane change recommendation is made or the driver makes the intention to change lanes. If the lane change safety check fails, then this lane change should not be executed.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of implementing the autonomous lane change safety check for a vehicle comprising:
selecting at least one object from sensor data for analysis with an electronic control unit (“ECU”);
mapping the at least one object relative to the vehicle and a current lane of travel with the ECU;
assessing the object data of at least one object for at least one of, the relative object position, object velocity, relative object velocity, and intended vehicle path with the ECU;
assigning an object threat value for the at least one object based on the object map and the object data;
grouping with the ECU the at least one object based the object threat value;
determining with the ECU an overall critical value from the object threat value for the at least one object;
filtering with the ECU the critical value to reduce signal noise; and
comparing with the ECU the critical value to a predetermined criticality threshold, wherein the lane change safety check is failed when the critical value is over the threshold.

2. The method of claim 1, assigning the object threat value further comprising:
determining a first object threat factor for the at least one object;
determining a second object threat factor for the at least one object;
determining a third object threat factor for the at least one object; and
comparing the first, second and third object threat factors and selecting the largest factor as the object threat value for the at least one object.

3. The method of claim 2, wherein the first object threat factor is based on a time to collision for the at least one object, the second object threat factor is based on a headway distance between the vehicle and the at least one object, and the third threat factor is based on a lateral distance between the vehicle and the object.

4. The method of claim 2, wherein assigning the object threat value further comprises at least one more object threat factor for the at least one object.

5. The method of claim 1, further comprising sending instructions to abort an autonomous lane change maneuver when the lane change safety check is failed.

6. An autonomous driving system for a vehicle comprising:
an electronic control unit (“ECU”) for receiving sensor data from a plurality of vehicle sensors, wherein the ECU includes instructions for implementing an autonomous lane change safety check technique comprising:
selecting at least one object from the sensor data for analysis;
mapping the at least one object relative to the vehicle and a current lane of travel;
assessing the object data of at least one object for at least one of, the relative object position, object velocity, relative object velocity, and intended vehicle path;
assigning an object threat value for the at least one object based on the object map and the object data;
grouping the at least one object based the object threat value;
determining an overall critical value from the object threat value for the at least one object;
filtering the critical value to reduce signal noise; and
comparing the critical value to a predetermined criticality threshold, wherein the lane change safety check is failed when the critical value is over the threshold.

7. The system of claim 6, wherein the ECU includes further instructions for assigning the object threat value further comprising:
determining a first object threat factor for the at least one object;
determining a second object threat factor for the at least one object;
determining a third object threat factor for the at least one object; and
comparing the first, second and third object threat factors and selecting the largest factor as the object threat value for the at least one object.

8. The system of claim 7, wherein the first object threat factor is based on a time to collision for the at least one object, the second object threat factor is based on a headway distance between the vehicle and the at least one object, and the third threat factor is based on a lateral distance between the vehicle and the object.

9. The system of claim 6, wherein the ECU includes further instructions for assigning the object threat value further comprising assigning the object threat value further comprises at least one more object threat factor for the at least one object.

10. The system of claim 6, wherein the ECU includes further instructions for assigning the object threat value further comprising sending instructions to abort an autonomous lane change maneuver when the lane change safety check is failed.
